(19) United States
(12) Patent Application Publication
(10) Pub. No.: US 2025/0047239 A1
(43) Pub. Date: Feb. 6, 2025

(54) ELECTRICAL COMPONENTS FOR PHOTOVOLTAIC SYSTEMS

(71) Applicant: GAF Energy LLC, Parsippany, NJ (US)

(72) Inventors: Gabriela Bunea, San Jose, CA (US); Thierry Nguyen, San Francisco, CA (US); Lewis Abra, San Francisco, CA (US)

(21) Appl. No.: 18/802,711

(22) Filed: Aug. 13, 2024

Related U.S. Application Data
(63) Continuation of application No. 17/703,671, filed on Mar. 24, 2022, now Pat. No. 12,095,415.
(60) Provisional application No. 63/167,475, filed on Mar. 29, 2021.

(51) Int. Cl. H02S 40/34; H02S 20/23; H02S 40/32

(52) U.S. Cl. CPC H02S 40/34; H02S 20/23; H02S 40/32

(57) ABSTRACT

A system includes at least one photovoltaic module installed on a roof deck, at least one electrical connector electrically connected to the photovoltaic module, and at least one electrical component electrically and removably connected to the electrical connector. The electrical component includes a housing and an electronic component located within the housing. The electronic component includes at least one of an optimizer, a rapid shutdown device, or an inverter. The electrical component is separate from the photovoltaic module and is configured to be disconnected from the electrical connector while the photovoltaic module remains installed on the roof deck.

### CROSS-REFERENCE TO RELATED APPLICATION

This application is a continuation of commonly-owned, co-pending U.S. patent application Ser. No. 17/703,671, filed Mar. 24, 2022, entitled “ELECTRICAL COMPONENTS FOR PHOTOVOLTAIC SYSTEMS,” which claims the benefit of commonly-owned, co-pending U.S. Provisional Patent Application Ser. No. 63/167,475, filed Mar. 29, 2021, entitled “ELECTRICAL COMPONENTS FOR PHOTOVOLTAIC SYSTEMS,” the contents of which are incorporated herein by reference in their entirety.

### FIELD OF THE INVENTION

The present invention relates to electrical components and, more particularly, electrical components having replaceable electronic components for photovoltaic systems.

### BACKGROUND

Photovoltaic systems having solar panels are commonly installed on roofing of structures. What is needed are low profile electrical components with replaceable electronic components configured for use with photovoltaic systems installed on roof decks.

### SUMMARY

In some embodiments, a system includes at least one photovoltaic module installed on a roof deck; at least one electrical connector electrically connected to the at least one photovoltaic module; and at least one electrical component electrically and removably connected to the at least one electrical connector, wherein the at least one electrical component includes a housing, and an electronic component located within the housing, wherein the electronic component includes at least one of an optimizer, a rapid shutdown device, or an inverter, wherein the at least one electrical component is separate from the at least one photovoltaic module, and wherein the at least one electrical component is configured to be disconnected from the at least one electrical connector while the at least one photovoltaic module remains installed on the roof deck.

In some embodiments, the electronic component is overmolded to the housing. In some embodiments, the housing includes a base and a cap removably attached to the base. In some embodiments, the electronic component is attached to the cap, and wherein the electronic component is removably attached to the base. In some embodiments, the cap includes at least one tab and the base includes at least one slot that is sized and shaped to removably receive the at least one tab. In some embodiments, the at least one tab includes a plurality of tabs and the at least one slot includes a plurality of slots each of which is sized and shaped to removably receive a corresponding one of the plurality of tabs. In some embodiments, the system further includes an O-ring attached to the cap. In some embodiments, the system further includes a gel located within the at least one slot. In some embodiments, the housing has a thickness of 1 mm to 30 mm.

In some embodiments, the system further includes at least one wireway installed proximate to an end of the at least one photovoltaic module, and wherein the at least one electrical component is located within the at least one wireway. In some embodiments, the system further includes at least one cover, wherein the at least one cover is removably attached to the at least one wireway, wherein the at least one cover includes an interior surface, wherein the at least one wireway includes an exterior surface, wherein the cap is attached to the interior surface of the at least one cover, and wherein the base is attached to the exterior surface of the at least one wireway.

In some embodiments, the at least one photovoltaic module includes a plurality of photovoltaic modules, and wherein the at least one electrical component includes a plurality of electrical components. In some embodiments, the at least one photovoltaic module includes first layer. In some embodiments, the first layer includes a polymer. In some embodiments, the polymer is selected from the group consisting of thermoplastic polyolefin (TPO), polyethylene terephthalate (PET), polyethylene naphthalate (PEN), polyetheretherketone (PEEK), polyaryletherketone (PAEK), polyarylate (PAR), polyetherimide (PEI), polyarylsulfone (PAS), polyethersulfone (PES), polyamideimide (PAI), or polyimide; polyvinyl chloride (PVC); ethylene propylene diene monomer (EPDM) rubber; silicone rubber; fluoropolymers-ethylene tetrafluoroethylene (ETFE), polyvinylidene fluoride (PVDF), tetrafluoroethylene-hexafluoropropylene copolymers (FEP), and tetrafluoroethylene-hexafluoropropylene-vinylidene fluoride copolymers (THV), and blends thereof. In some embodiments, the first layer includes a head lap, and wherein the at least one electrical component is located on the head lap. In some embodiments, at least a portion of a first one of the photovoltaic modules overlays at least a portion of the head lap of a second one of the photovoltaic modules, and wherein the at least one electrical component is located intermediate the at least a portion of the first one of the photovoltaic modules and the head lap of the second one of the photovoltaic modules. In some embodiments, the first layer includes a step flap, and wherein the at least one electrical component is located on the step flap. In some embodiments, at least a portion a first one of the photovoltaic modules overlays at least a portion of the step flap of a second one of the photovoltaic modules, and wherein the at least one electrical component is located intermediate the at least a portion of the first one of the photovoltaic modules and the step flap of the second one of the photovoltaic modules.

In some embodiments, a system includes at least one photovoltaic module installed on a roof deck; at least one electrical connector electrically connected to the at least one photovoltaic module; and at least one electrical component housing electrically connected to the at least one electrical connector, wherein the at least one electrical component housing includes a base and a cap, wherein the cap (a) is electrically and removably attached to the base, and (b) includes at least one electronic component located within the cap, and wherein the at least one electronic component includes at least one of an optimizer, a rapid shutdown device, or an inverter.

### BRIEF DESCRIPTION OF THE DRAWINGS

FIG. 1 is a schematic view of an embodiment of an electrical component;

FIG. 2 is schematic view of another embodiment of an electrical component;

FIG. 3 is a cross-sectional view, taken along section lines A-A and looking in the direction of the arrows, of the electrical component shown in FIG. 2;

FIG. 4 is a schematic view of the electrical component shown in FIG. 2, with an electronic component employed by the electrical component removed from an associated housing;

FIG. 5 is a schematic view of another embodiment of an electrical component, with an electronic component employed by the electrical component removed from an associated housing;

FIG. 6 is a schematic view of another embodiment of an electrical component, with an electronic component employed by the electrical component removed from an associated housing;

FIG. 7A is a top perspective schematic view of an embodiment of a photovoltaic system installed on a roof deck and including a plurality of embodiments of electrical components;

FIGS. 7B and 7C are side cross sectional views of embodiments of a wireway and cover;

FIGS. 8 and 9 are top plan schematic views of embodiments of a photovoltaic module including embodiments of an electrical component; and

FIGS. 10 and 11 are a top perspective and side elevational schematic views of an embodiment of a photovoltaic system installed on a roof deck and including a plurality of embodiments of electrical components.

### DETAILED DESCRIPTION

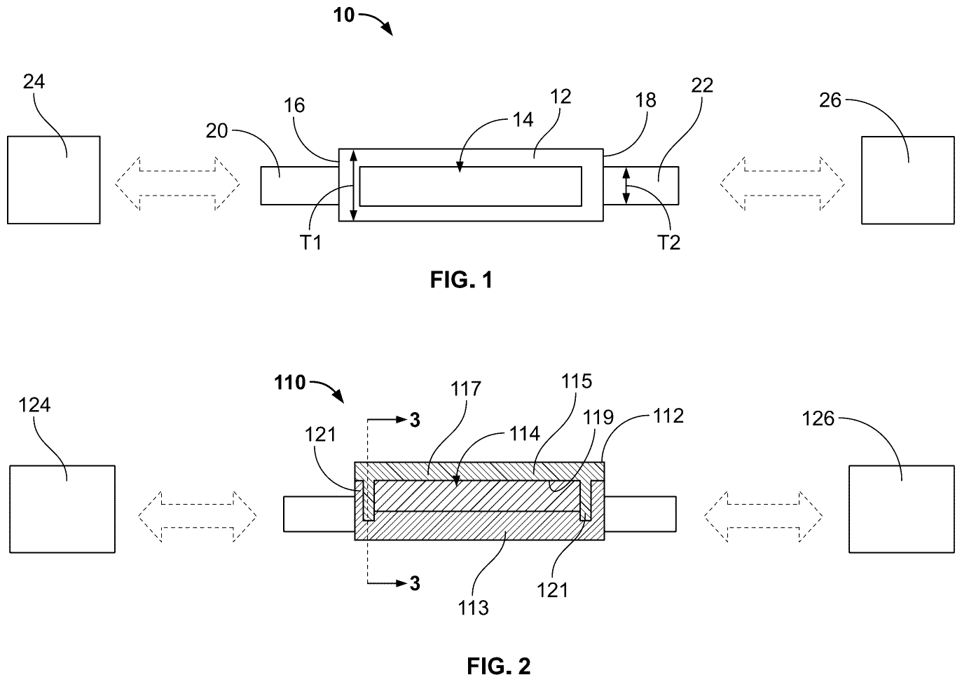

Referring to FIG. 1, in an embodiment, an electrical component 10 includes a housing 12 and an electronic component 14 located within the housing 12. In some embodiments, the electronic component 14 is overmolded with the housing 12. In some embodiments, the electronic component 14 is embedded within the housing 12. As used herein, the term “embedded” means partially or fully enveloped or enclosed, and with respect to certain embodiments of the electrical component 10, the electronic component 14 is fully enveloped by or enclosed within the housing 12, or partially enveloped by or enclosed within the housing 12.

In some embodiments, an entire exterior surface area of the electronic component 14 is embedded within the housing 12. In some embodiments, 50% to 100% of an exterior surface area of the electronic component 14 is embedded within the housing 12. In some embodiments, 55% to 100% of an exterior surface area of the electronic component 14 is embedded within the housing 12. In some embodiments, 60% to 100% of an exterior surface area of the electronic component 14 is embedded within the housing 12. In some embodiments, 65% to 100% of an exterior surface area of the electronic component 14 is embedded within the housing 12. In some embodiments, 70% to 100% of an exterior surface area of the electronic component 14 is embedded within the housing 12. In some embodiments, 75% to 100% of an exterior surface area of the electronic component 14 is embedded within the housing 12. In some embodiments, 80% to 100% of an exterior surface area of the electronic component 14 is embedded within the housing 12. In some embodiments, 85% to 100% of an exterior surface area of the electronic component 14 is embedded within the housing 12. In some embodiments, 90% to 100% of an exterior surface area of the electronic component 14 is embedded within the housing 12. In some embodiments, 95% to 100% of an exterior surface area of the electronic component 14 is embedded within the housing 12.

In some embodiments, 50% to 95% of an exterior surface area of the electronic component 14 is embedded within the housing 12. In some embodiments, 55% to 95% of an exterior surface area of the electronic component 14 is embedded within the housing 12. In some embodiments, 60% to 95% of an exterior surface area of the electronic component 14 is embedded within the housing 12. In some embodiments, 65% to 95% of an exterior surface area of the electronic component 14 is embedded within the housing 12. In some embodiments, 70% to 95% of an exterior surface area of the electronic component 14 is embedded within the housing 12. In some embodiments, 75% to 95% of an exterior surface area of the electronic component 14 is embedded within the housing 12. In some embodiments, 80% to 95% of an exterior surface area of the electronic component 14 is embedded within the housing 12. In some embodiments, 85% to 95% of an exterior surface area of the electronic component 14 is embedded within the housing 12. In some embodiments, 90% to 95% of an exterior surface area of the electronic component 14 is embedded within the housing 12.

In some embodiments, 50% to 90% of an exterior surface area of the electronic component 14 is embedded within the housing 12. In some embodiments, 55% to 90% of an exterior surface area of the electronic component 14 is embedded within the housing 12. In some embodiments, 60% to 90% of an exterior surface area of the electronic component 14 is embedded within the housing 12. In some embodiments, 65% to 90% of an exterior surface area of the electronic component 14 is embedded within the housing 12. In some embodiments, 70% to 90% of an exterior surface area of the electronic component 14 is embedded within the housing 12. In some embodiments, 75% to 90% of an exterior surface area of the electronic component 14 is embedded within the housing 12. In some embodiments, 80% to 90% of an exterior surface area of the electronic component 14 is embedded within the housing 12. In some embodiments, 85% to 90% of an exterior surface area of the electronic component 14 is embedded within the housing 12.

In some embodiments, 50% to 85% of an exterior surface area of the electronic component 14 is embedded within the housing 12. In some embodiments, 55% to 85% of an exterior surface area of the electronic component 14 is embedded within the housing 12. In some embodiments, 60% to 85% of an exterior surface area of the electronic component 14 is embedded within the housing 12. In some embodiments, 65% to 85% of an exterior surface area of the electronic component 14 is embedded within the housing 12. In some embodiments, 70% to 85% of an exterior surface area of the electronic component 14 is embedded within the housing 12. In some embodiments, 75% to 85% of an exterior surface area of the electronic component 14 is embedded within the housing 12. In some embodiments, 80% to 85% of an exterior surface area of the electronic component 14 is embedded within the housing 12.

In some embodiments, 50% to 80% of an exterior surface area of the electronic component 14 is embedded within the housing 12. In some embodiments, 55% to 80% of an exterior surface area of the electronic component 14 is embedded within the housing 12. In some embodiments, 60% to 80% of an exterior surface area of the electronic component 14 is embedded within the housing 12. In some embodiments, 65% to 80% of an exterior surface area of the electronic component 14 is embedded within the housing 12. In some embodiments, 70% to 80% of an exterior surface area of the electronic component 14 is embedded within the housing 12. In some embodiments, 75% to 80% of an exterior surface area of the electronic component 14 is embedded within the housing 12.

In some embodiments, 50% to 75% of an exterior surface area of the electronic component 14 is embedded within the housing 12. In some embodiments, 55% to 75% of an exterior surface area of the electronic component 14 is embedded within the housing 12. In some embodiments, 60% to 75% of an exterior surface area of the electronic component 14 is embedded within the housing 12. In some embodiments, 65% to 75% of an exterior surface area of the electronic component 14 is embedded within the housing 12. In some embodiments, 70% to 75% of an exterior surface area of the electronic component 14 is embedded within the housing 12.

In some embodiments, 50% to 70% of an exterior surface area of the electronic component 14 is embedded within the housing 12. In some embodiments, 55% to 70% of an exterior surface area of the electronic component 14 is embedded within the housing 12. In some embodiments, 60% to 70% of an exterior surface area of the electronic component 14 is embedded within the housing 12. In some embodiments, 65% to 70% of an exterior surface area of the electronic component 14 is embedded within the housing 12.

In some embodiments, 50% to 65% of an exterior surface area of the electronic component 14 is embedded within the housing 12. In some embodiments, 55% to 65% of an exterior surface area of the electronic component 14 is embedded within the housing 12. In some embodiments, 60% to 65% of an exterior surface area of the electronic component 14 is embedded within the housing 12. In some embodiments, 50% to 60% of an exterior surface area of the electronic component 14 is embedded within the housing 12. In some embodiments, 55% to 60% of an exterior surface area of the electronic component 14 is embedded within the housing 12. In some embodiments, 50% to 55% of an exterior surface area of the electronic component 14 is embedded within the housing 12.

In some embodiments, 50% of an exterior surface area of the electronic component 14 is embedded within the housing 12. In some embodiments, 55% of the exterior surface area of the electronic component 14 is embedded within the housing 12. In some embodiments, 60% of the exterior surface area of the electronic component 14 is embedded within the housing 12. In some embodiments, 65% of the exterior surface area of the electronic component 14 is embedded within the housing 12. In some embodiments, 70% of the exterior surface area of the electronic component 14 is embedded within the housing 12. In some embodiments, 75% of the exterior surface area of the electronic component 14 is embedded within the housing 12. In some embodiments, 80% of the exterior surface area of the electronic component 14 is embedded within the housing 12. In some embodiments, 85% of the exterior surface area of the electronic component 14 is embedded within the housing 12. In some embodiments, 90% of the exterior surface area of the electronic component 14 is embedded within the housing 12. In some embodiments, 95% of the exterior surface area of the electronic component 14 is embedded within the housing 12. In some embodiments, 100% of the exterior surface area of the electronic component 14 is embedded within the housing 12.

In some embodiments, the electronic component 14 includes a power optimizer. In some embodiments, the electronic component 14 includes an inverter. In some embodiments, the electronic component 14 includes a diode. In some embodiments, the electronic component 14 includes a rapid shutdown device (RSD). In some embodiments, the electronic component 14 is a component of a junction box.

In some embodiments, the housing 12 includes a first end 16 and a second end 18 opposite the first end 16. In some embodiments, a first connector 20 extends from the first end 16. In some embodiments, a second connector 22 extends from the second end 18. In some embodiments, the first connector 20 is configured to be connected to a first mating connector 24. In some embodiments, the second connector 22 is configured to be connected to a second mating connector 26. In some embodiments, the first mating connector 24 is electrically connected to a photovoltaic system. In some embodiments, the second mating connector 26 is electrically connected to a photovoltaic system.

In some embodiments, the housing 12 has a thickness T1 of 1 mm to 30 mm. In some embodiments, the housing 12 has a thickness T1 of 5 mm to 30 mm. In some embodiments, the housing 12 has a thickness T1 of 10 mm to 30 mm. In some embodiments, the housing 12 has a thickness T1 of 15 mm to 30 mm. In some embodiments, the housing 12 has a thickness T1 of 20 mm to 30 mm. In some embodiments, the housing 12 has a thickness T1 of 25 mm to 30 mm. In some embodiments, the housing 12 has a thickness T1 of 1 mm to 25 mm. In some embodiments, the housing 12 has a thickness T1 of 5 mm to 25 mm. In some embodiments, the housing 12 has a thickness T1 of 10 mm to 25 mm. In some embodiments, the housing 12 has a thickness T1 of 15 mm to 25 mm. In some embodiments, the housing 12 has a thickness T1 of 20 mm to 25 mm.

In some embodiments, the housing 12 has a thickness T1 of 1 mm to 20 mm. In some embodiments, the housing 12 has a thickness T1 of 5 mm to 20 mm. In some embodiments, the housing 12 has a thickness T1 of 10 mm to 20 mm. In some embodiments, the housing 12 has a thickness T1 of 15 mm to 20 mm. In some embodiments, the housing 12 has a thickness T1 of 1 mm to 15 mm. In some embodiments, the housing 12 has a thickness T1 of 5 mm to 15 mm. In some embodiments, the housing 12 has a thickness T1 of 10 mm to 15 mm. In some embodiments, the housing 12 has a thickness T1 of 1 mm to 10 mm. In some embodiments, the housing 12 has a thickness T1 of 5 mm to 10 mm. In some embodiments, the housing 12 has a thickness T1 of 1 mm to 5 mm.

In some embodiments, the housing 12 has a thickness T1 of 1 mm. In some embodiments, the housing 12 has a thickness T1 of 5 mm. In some embodiments, the housing 12 has a thickness T1 of 10 mm. In some embodiments, the housing 12 has a thickness T1 of 15 mm. In some embodiments, the housing 12 has a thickness T1 of 20 mm. In some embodiments, the housing 12 has a thickness T1 of 25 mm. In some embodiments, the housing 12 has a thickness T1 of 30 mm.

In some embodiments, the first connector 20 is a flat ribbon cable. In some embodiments, the second connector 22 is a flat ribbon cable. In some embodiments, the first connector 20 and the second connector 22 are integrated with the housing 12. In some embodiments, the first connector 20 and the second connector 22 are electrically connected to the electronic component 14. In some embodiments, the first connector 20 and the second connector 22 are overmolded into the housing 12.

In some embodiments, each of the first connector 20 and the second connector 22 has a thickness T2 of 1 mm to 10 mm. In some embodiments, each of the first connector 20 and the second connector 22 has a thickness T2 of 1 mm to 9 mm. In some embodiments, each of the first connector 20 and the second connector 22 has a thickness T2 of 1 mm to 8 mm. In some embodiments, each of the first connector 20 and the second connector 22 has a thickness T2 of 1 mm to 7 mm. In some embodiments, each of the first connector 20 and the second connector 22 has a thickness T2 of 1 mm to 6 mm. In some embodiments, each of the first connector 20 and the second connector 22 has a thickness T2 of 1 mm to 5 mm. In some embodiments, each of the first connector 20 and the second connector 22 has a thickness T2 of 1 mm to 4 mm. In some embodiments, each of the first connector 20 and the second connector 22 has a thickness T2 of 1 mm to 3 mm. In some embodiments, each of the first connector 20 and the second connector 22 has a thickness T2 of 1 mm to 2 mm.

In some embodiments, each of the first connector 20 and the second connector 22 has a thickness T2 of 2 mm to 10 mm. In some embodiments, each of the first connector 20 and the second connector 22 has a thickness T2 of 2 mm to 9 mm. In some embodiments, each of the first connector 20 and the second connector 22 has a thickness T2 of 2 mm to 8 mm. In some embodiments, each of the first connector 20 and the second connector 22 has a thickness T2 of 2 mm to 7 mm. In some embodiments, each of the first connector 20 and the second connector 22 has a thickness T2 of 2 mm to 6 mm. In some embodiments, each of the first connector 20 and the second connector 22 has a thickness T2 of 2 mm to 5 mm. In some embodiments, each of the first connector 20 and the second connector 22 has a thickness T2 of 2 mm to 4 mm. In some embodiments, each of the first connector 20 and the second connector 22 has a thickness T2 of 2 mm to 3 mm.

In some embodiments, each of the first connector 20 and the second connector 22 has a thickness T2 of 3 mm to 10 mm. In some embodiments, each of the first connector 20 and the second connector 22 has a thickness T2 of 3 mm to 9 mm. In some embodiments, each of the first connector 20 and the second connector 22 has a thickness T2 of 3 mm to 8 mm. In some embodiments, each of the first connector 20 and the second connector 22 has a thickness T2 of 3 mm to 7 mm. In some embodiments, each of the first connector 20 and the second connector 22 has a thickness T2 of 3 mm to 6 mm. In some embodiments, each of the first connector 20 and the second connector 22 has a thickness T2 of 3 mm to 5 mm. In some embodiments, each of the first connector 20 and the second connector 22 has a thickness T2 of 3 mm to 4 mm.

In some embodiments, each of the first connector 20 and the second connector 22 has a thickness T2 of 4 mm to 10 mm. In some embodiments, each of the first connector 20 and the second connector 22 has a thickness T2 of 4 mm to 9 mm. In some embodiments, each of the first connector 20 and the second connector 22 has a thickness T2 of 4 mm to 8 mm. In some embodiments, each of the first connector 20 and the second connector 22 has a thickness T2 of 4 mm to 7 mm. In some embodiments, each of the first connector 20 and the second connector 22 has a thickness T2 of 4 mm to 6 mm. In some embodiments, each of the first connector 20 and the second connector 22 has a thickness T2 of 4 mm to 5 mm.

In some embodiments, each of the first connector 20 and the second connector 22 has a thickness T2 of 5 mm to 10 mm. In some embodiments, each of the first connector 20 and the second connector 22 has a thickness T2 of 5 mm to 9 mm. In some embodiments, each of the first connector 20 and the second connector 22 has a thickness T2 of 5 mm to 8 mm. In some embodiments, each of the first connector 20 and the second connector 22 has a thickness T2 of 5 mm to 7 mm. In some embodiments, each of the first connector 20 and the second connector 22 has a thickness T2 of 5 mm to 6 mm. In some embodiments, each of the first connector 20 and the second connector 22 has a thickness T2 of 6 mm to 10 mm. In some embodiments, each of the first connector 20 and the second connector 22 has a thickness T2 of 6 mm to 9 mm. In some embodiments, each of the first connector 20 and the second connector 22 has a thickness T2 of 6 mm to 8 mm. In some embodiments, each of the first connector 20 and the second connector 22 has a thickness T2 of 6 mm to 7 mm. In some embodiments, each of the first connector 20 and the second connector 22 has a thickness T2 of 7 mm to 10 mm. In some embodiments, each of the first connector 20 and the second connector 22 has a thickness T2 of 7 mm to 9 mm. In some embodiments, each of the first connector 20 and the second connector 22 has a thickness T2 of 7 mm to 8 mm. In some embodiments, each of the first connector 20 and the second connector 22 has a thickness T2 of 8 mm to 10 mm. In some embodiments, each of the first connector 20 and the second connector 22 has a thickness T2 of 8 mm to 9 mm. In some embodiments, each of the first connector 20 and the second connector 22 has a thickness T2 of 9 mm to 10 mm.

In some embodiments, each of the first connector 20 and the second connector 22 has a thickness T2 of 1 mm. In some embodiments, each of the first connector 20 and the second connector 22 has a thickness T2 of 2 mm. In some embodiments, each of the first connector 20 and the second connector 22 has a thickness T2 of 3 mm. In some embodiments, each of the first connector 20 and the second connector 22 has a thickness T2 of 4 mm. In some embodiments, each of the first connector 20 and the second connector 22 has a thickness T2 of 5 mm. In some embodiments, each of the first connector 20 and the second connector 22 has a thickness T2 of 6 mm. In some embodiments, each of the first connector 20 and the second connector 22 has a thickness T2 of 7 mm. In some embodiments, each of the first connector 20 and the second connector 22 has a thickness T2 of 8 mm. In some embodiments, each of the first connector 20 and the second connector 22 has a thickness T2 of 9 mm. In some embodiments, each of the first connector 20 and the second connector 22 has a thickness T2 of 10 mm.

In some embodiments, the electrical component 10 is configured to be electrically connected to at least one photovoltaic module. In some embodiments, the electrical component 10 is configured to be electrically connected to a plurality of photovoltaic modules. In some embodiments, the electrical component 10 is a component that is separate and distinct from the photovoltaic module. In some embodiments, the electrical component 10 is not embedded within the photovoltaic module. In some embodiments, the electrical component 10 is configured to be disconnected from the first mating connector 24 and the second mating connector 26 while the photovoltaic module remains installed on the roof deck. In some embodiments, if the electronic component 14 requires an upgrade, repair or replacement, a user may disconnect the electrical component 10 from the first mating connector 24 and the second mating connector 26 and replace the electrical component 10 with a new electrical component, or have the electrical component 10 repaired and reinstalled, without the need to remove or uninstall the photovoltaic module from the roof deck. In some embodiments, an upgrade of the electronic component 10 may include a newer or latest model of same.

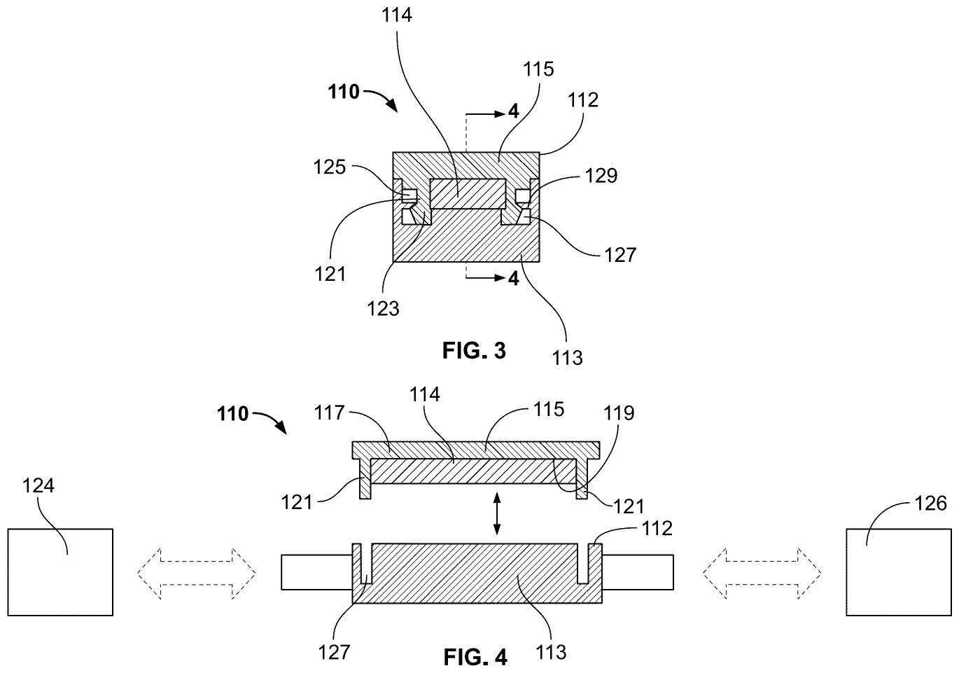

FIGS. 2 through 4 show an embodiment of an electrical component 110. The electrical component 110 includes a structure and function similar to those of the electrical component 10 except as illustrated and described below. In some embodiments, the electrical component 110 includes a housing 112 having a base 113 and a cap 115 removably attached to the base 113. In some embodiments, an electronic component 114 is attached to the cap 115. In some embodiments, the electronic component 114 is removably attached to the cap 115. In some embodiments, the electronic component 114 is attached to the cap 115 by a fastener. In some embodiments, the electronic component 114 is attached to the cap 115 by an adhesive. In some embodiments, the electronic component 114 is attached to the cap 115 by ultrasonic welding. In some embodiments, the cap 115 includes a cover 117 having a first surface 119 and at least one tab 121 extending outwardly from the first surface 119. In some embodiments, the at least one tab 121 includes a plurality of the tabs 121. In some embodiments, each of the tabs 121 includes a hook member 123. In some embodiments, the electronic component 114 is located intermediate the tabs 121.

In some embodiments, the housing 112 is made from a thermoplastic material. In some embodiments, the housing 112 is made from poly (p-phenylene oxide)/poly(p-phenylene ether) (PPE). In some embodiments, the housing 112 is made from fiber-reinforced plastic (FRP). In some embodiments, the housing 112 is made from fiberglass reinforced polymers.

In some embodiments, the base 113 includes a pair of elongated slots 125, 127 extending longitudinally from a first end to a second end of the base 113. In some embodiments, tab portions 129 extend within each of the slots 125, 127. In some embodiments, the slots 125, 127 are sized and shaped to removably receive a corresponding one of the pair of tabs 121 of the cap 115, and the each of the tab portions 129 is sized and shaped to engage removably a corresponding one of the hook members 123 of the tabs 121. In some embodiments, the tabs 121 are pin connectors and the slots 125, 127 are sockets. In some embodiments, the tabs 121 and the slots 125, 127 include a blade-type connection system. In some embodiments, the tabs 121 and the slots 125, 127 include a spade or fork terminal connection system. In some embodiments, the tabs 121 and the slots 125, 127 include a universal serial bus (USB) connection system. In some embodiments, if the electronic component 114 requires an upgrade, repair or replacement, a user may remove the cap 115 which includes the electronic component 114, from the base 113 without the need to remove the housing 112 (e.g., the base 113) of the electrical component 110 from mating connectors 124, 126 or to remove or uninstall the photovoltaic module. In some embodiments, a user may upgrade or replace the electronic component 114 with a new or upgraded electronic component, or a repaired electronic component 114. In some embodiments, the upgrade to the electronic component 114 may be the result of changes, revisions or updates in governmental or industry standards, codes, and guidelines for roofing systems, photovoltaic systems, electronic systems, and/or electrical systems.

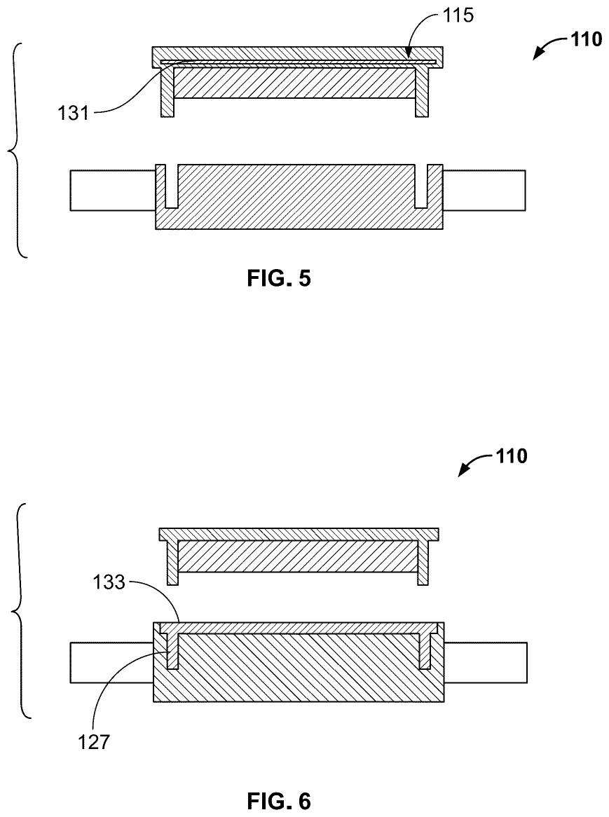

Referring to FIG. 5, in an embodiment, the electrical component 110 includes an O-ring 131 positioned on the cap 115. In some embodiments, the O-ring 131 resists water ingress within the housing 112 of the electrical component 110. In some embodiments, the O-ring 131 is a silicone O-ring. Referring to FIG. 6, in an embodiment, the electrical component 110 includes a gel 133. In some embodiments, the gel 133 is a silicone gel. In some embodiments, the slots 125, 127 of the housing 112 are filled with the gel 133. In some embodiments, the gel 133 resists water ingress within the housing 112 of the electrical component 110.

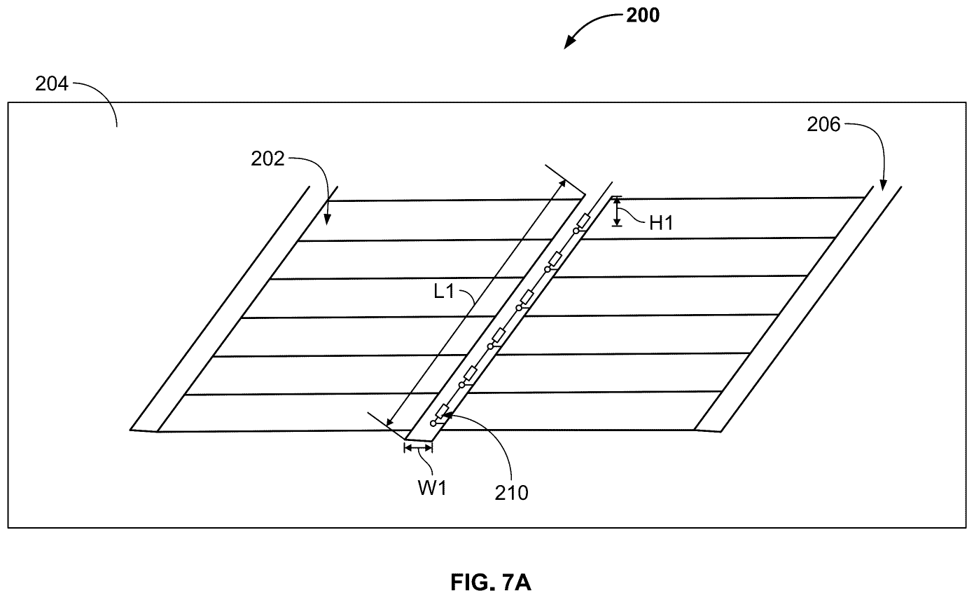

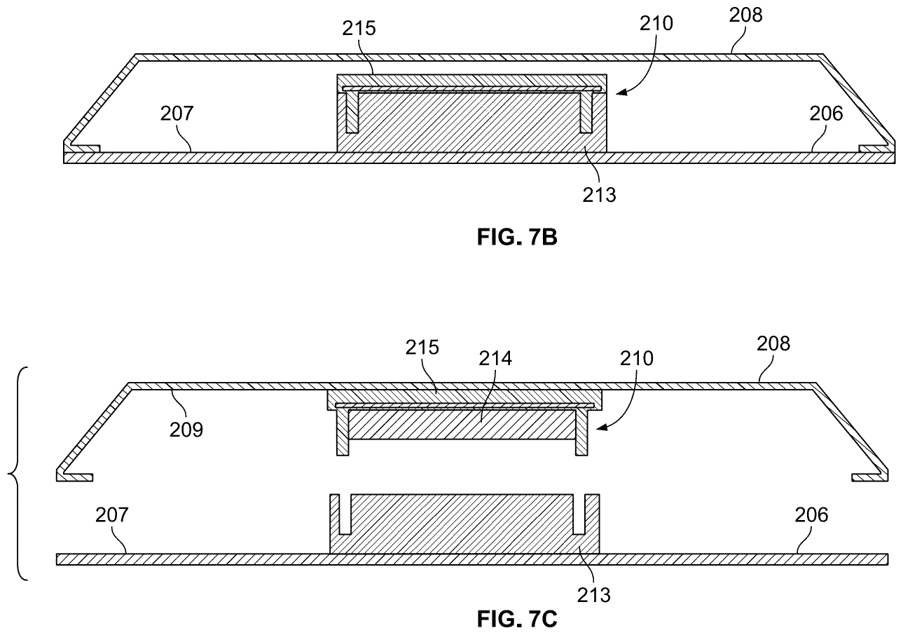

Referring to FIG. 7A and 7B, in some embodiments, a roofing system 200 includes a plurality of photovoltaic modules 202 installed on a roof deck 204, and at least one wireway 206 installed on the roof deck 204 proximate to the photovoltaic modules 202. In some embodiments, the at least one wireway 206 is installed intermediate the plurality of photovoltaic modules 202. In some embodiments, the at least one wireway 206 is installed proximate to inner ends of the photovoltaic modules 202. In some embodiments, the at least one wireway 206 is installed proximate to outer ends of the photovoltaic modules 202.

In some embodiments, the at least one wireway 206 is rectangular in shape. In some embodiments, the at least one wireway 206 is sized and shaped to receive at least one electrical component 210. In some embodiments, the at least one wireway 206 is sized and shaped to receive a plurality of the electrical components 210. In some embodiments, each of the electrical components 210 has a structure and function similar to those of the electrical component 10. In other embodiments, each of the electrical components 210 has a structure and function similar to those of the electrical component 110. In some embodiments, the electrical components 210 are electrically connected to one another. In some embodiments, the electrical component 210 is electrically connected to one of the photovoltaic modules 202. In some embodiments, the electrical component 210 is electrically connected to each of the photovoltaic modules 202.

Referring to FIG. 7B, in some embodiments, the at least one wireway 206 includes a cover 208. In some embodiments, the cover 208 is removably attached to the at least one wireway 206. In some embodiments, the at least one wireway 206 includes a single wireway installed proximate to the inner end of each of the plurality of photovoltaic modules 202. In some embodiments, the at least one wireway 206 includes a single wireway installed proximate to the outer end of each of the plurality of photovoltaic modules 202. In some embodiments, the cover 208 covers the electrical components 210 when installed within the wireway 206. In some embodiments, a base 213 of the electrical component 210 is juxtaposed with a surface 207 of the wireway 206. In some embodiments, a base 213 of the electrical component 210 is located on the surface 207 of the wireway 206. In some embodiments, the base 213 is attached to the surface 207 of the wireway 206. In some embodiments, the base 213 is attached to the surface 207 of the wireway 206 by an adhesive. In some embodiments, the base 213 is ultrasonically welded to the surface 207. In some embodiments, the base 213 is heat welded to the surface 207. In some embodiments, the base 213 is thermally bonded to the surface 207. In some embodiments, the base 213 is not adhered or attached to the surface 207. In some embodiments, a cap 215 including the electronic component 214 is removably attached to the base 213.

Referring to FIG. 7C, in some embodiments, the cap 215 is attached to an interior surface 209 of the cover 208. In some embodiments, the cap 215 is attached to the interior surface 209 of the wireway 206 by an adhesive. In some embodiments, the cap 215 is ultrasonically welded to the interior surface 209. In some embodiments, the cap 215 is heat welded to the interior surface 209. In some embodiments, the cap 215 is thermally bonded to the interior surface 209. In some embodiments, the cap 215 is not adhered or attached to the interior surface 209. In some embodiments, the cap 215 is removably attached to the base 213 when the cover 208 is installed on the surface 207 of the wireway 206. In some embodiments, the electronic component 214 is electronically connected to the photovoltaic system when the when the cover 208 is installed on the surface 207 of the wireway 206. In some embodiments, the electronic component 214 is removable from the cap 215 when the cover 208 in uninstalled from the wireway 206.

In some embodiments, the wireway 206 includes a length L1 of 100 mm to 450 mm. In some embodiments, the wireway 206 includes a length L1 of 100 mm to 400 mm. In some embodiments, the wireway 206 includes a length L1 of 100 mm to 350 mm. In some embodiments, the wireway 206 includes a length L1 of 100 mm to 300 mm. In some embodiments, the wireway 206 includes a length L1 of 100 mm to 250 mm. In some embodiments, the wireway 206 includes a length L1 of 100 mm to 200 mm. In some embodiments, the wireway 206 includes a length L1 of 100 mm to 150 mm.

In some embodiments, the wireway 206 includes a length L1 of 150 mm to 450 mm. In some embodiments, the wireway 206 includes a length L1 of 150 mm to 400 mm. In some embodiments, the wireway 206 includes a length L1 of 150 mm to 350 mm. In some embodiments, the wireway 206 includes a length L1 of 150 mm to 300 mm. In some embodiments, the wireway 206 includes a length L1 of 150 mm to 250 mm. In some embodiments, the wireway 206 includes a length L1 of 150 mm to 200 mm.

In some embodiments, the wireway 206 includes a length L1 of 200 mm to 450 mm. In some embodiments, the wireway 206 includes a length L1 of 200 mm to 400 mm. In some embodiments, the wireway 206 includes a length L1 of 200 mm to 350 mm. In some embodiments, the wireway 206 includes a length L1 of 200 mm to 300 mm. In some embodiments, the wireway 206 includes a length L1 of 200 mm to 250 mm.

In some embodiments, the wireway 206 includes a length L1 of 250 mm to 450 mm. In some embodiments, the wireway 206 includes a length L1 of 250 mm to 400 mm. In some embodiments, the wireway 206 includes a length L1 of 250 mm to 350 mm. In some embodiments, the wireway 206 includes a length L1 of 250 mm to 300 mm.

In some embodiments, the wireway 206 includes a length L1 of 300 mm to 450 mm. In some embodiments, the wireway 206 includes a length L1 of 300 mm to 400 mm. In some embodiments, the wireway 206 includes a length L1 of 300 mm to 350 mm. In some embodiments, the wireway 206 includes a length L1 of 350 mm to 450 mm. In some embodiments, the wireway 206 includes a length L1 of 350 mm to 400 mm. In some embodiments, the wireway 206 includes a length L1 of 400 mm to 450 mm.

In some embodiments, the wireway 206 includes a width W1 of 100 mm to 200 mm. In some embodiments, the wireway 206 includes a width W1 of 100 mm to 175 mm. In some embodiments, the wireway 206 includes a width W1 of 100 mm to 150 mm. In some embodiments, the wireway 206 includes a width W1 of 100 mm to 125 mm.

In some embodiments, the wireway 206 includes a width W1 of 125 mm to 200 mm. In some embodiments, the wireway 206 includes a width W1 of 125 mm to 175 mm. In some embodiments, the wireway 206 includes a width W1 of 125 mm to 150 mm. In some embodiments, the wireway 206 includes a width W1 of 150 mm to 200 mm. In some embodiments, the wireway 206 includes a width W1 of 150 mm to 175 mm. In some embodiments, the wireway 206 includes a width W1 of 175 mm to 200 mm.

In some embodiments, the wireway 206 includes a height H1 of 5 mm to 35 mm. In some embodiments, the wireway 206 includes a height H1 of 5 mm to 30 mm. In some embodiments, the wireway 206 includes a height H1 of 5 mm to 25 mm. In some embodiments, the wireway 206 includes a height H1 of 5 mm to 20 mm. In some embodiments, the wireway 206 includes a height H1 of 5 mm to 15 mm. In some embodiments, the wireway 206 includes a height H1 of 5 mm to 10 mm. In some embodiments, the wireway 206 includes a height H1 of 10 mm to 35 mm. In some embodiments, the wireway 206 includes a height H1 of 10 mm to 30 mm. In some embodiments, the wireway 206 includes a height H1 of 10 mm to 25 mm. In some embodiments, the wireway 206 includes a height H1 of 10 mm to 20 mm. In some embodiments, the wireway 206 includes a height H1 of 10 mm to 15 mm.

In some embodiments, the wireway 206 includes a height H1 of 15 mm to 35 mm. In some embodiments, the wireway 206 includes a height H1 of 15 mm to 30 mm. In some embodiments, the wireway 206 includes a height H1 of 15 mm to 25 mm. In some embodiments, the wireway 206 includes a height H1 of 15 mm to 20 mm. In some embodiments, the wireway 206 includes a height H1 of 20 mm to 35 mm. In some embodiments, the wireway 206 includes a height H1 of 20 mm to 30 mm. In some embodiments, the wireway 206 includes a height H1 of 20 mm to 25 mm. In some embodiments, the wireway 206 includes a height H1 of 25 mm to 35 mm. In some embodiments, the wireway 206 includes a height H1 of 25 mm to 30 mm. In some embodiments, the wireway 206 includes a height H1 of 30 mm to 35 mm.

In some embodiments, the wireway 206 includes a height H1 of 5 mm. In some embodiments, the wireway 206 includes a height H1 of 10 mm. In some embodiments, the wireway 206 includes a height H1 of 15 mm. In some embodiments, the wireway 206 includes a height H1 of 20 mm. In some embodiments, the wireway 206 includes a height H1 of 25 mm. In some embodiments, the wireway 206 includes a height H1 of 30 mm. In some embodiments, the wireway 206 includes a height H1 of 35 mm.

In some embodiments, the wireway 206 is made from a polymeric material. In some embodiments, the wireway 206 is made from polypropylene. In some embodiments, the wireway 206 is made from polyethylene. In some embodiments, the wireway 206 is made from metal. In some embodiments, the wireway 206 is made from aluminum.

In some embodiments, the at least one wireway 206 is moisture resistant. As used herein, the term “moisture resistant” means having a water transmission rate of less than or equal to 0.05 U.S. perms, as measured by ASTM E 96, Procedure B-Standard Test Methods for Water Vapor Transmission of Materials. In some embodiments, the wireway 206 withstands walking loads/step resistance that conforms to standards under UL 3741 test standards (UL Standard for Safety Photovoltaic Hazard Control). In some embodiments, the wireway 206 includes an axe impact resistance that conforms to standards under UL 3741 test standards. In some embodiments, the wireway 206 includes a body fall resistance that conforms to standards under UL 3741 test standards.

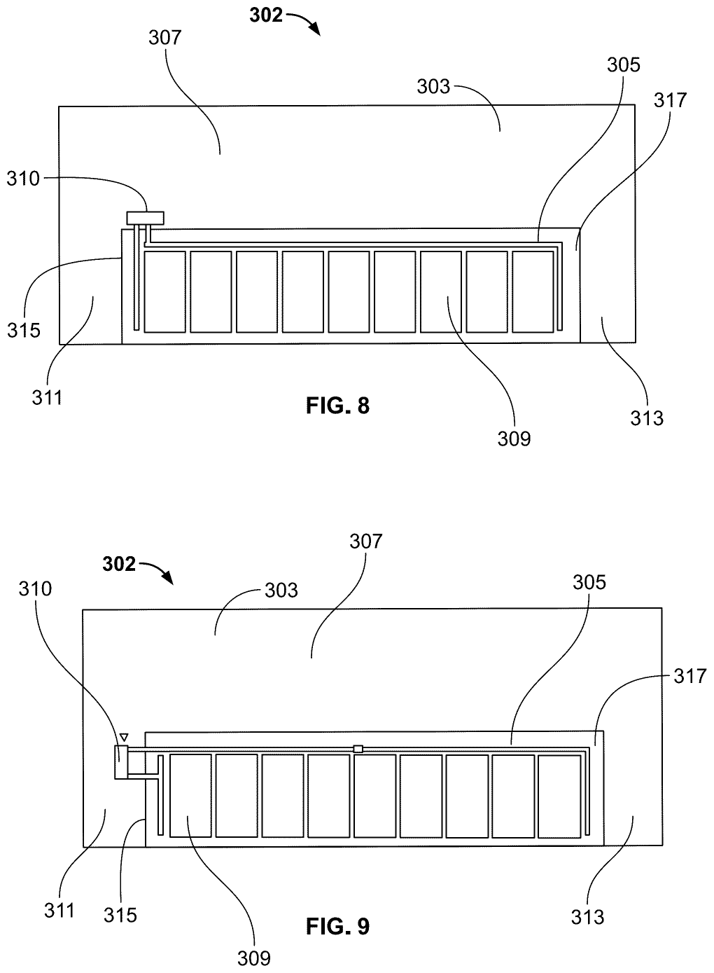

Referring to FIGS. 8 through 11, in an embodiment, a roofing system 300 includes a plurality of photovoltaic modules 302 installed on a roof deck 304. In some embodiments, each of the photovoltaic modules 302 includes a first layer 303 and a second layer 305 overlaying the first layer 303. In some embodiments, the first layer 303 includes a head lap 307. In some embodiments, the second layer 305 includes at least one solar cell 309. In some embodiments, the at least one solar cell 309 includes a plurality of the solar cells 309. In some embodiments, at least one of the plurality of photovoltaic modules 302 overlays at least the head lap 307 of another of the plurality of photovoltaic modules 302. In some embodiments, the first layer 303 includes a first step flap 311 adjacent an end 315 of the second layer 305 and a second step flap 313 adjacent an opposite end 317 of the second layer 305. In some embodiments, the first step flap 311 of at least one of the plurality of photovoltaic modules 302 overlays at least the second step flap 313 of another of the plurality of photovoltaic modules 302. In some embodiments, the second step flap 313 of at least one of the plurality of photovoltaic modules 302 overlays at least the first step flap 311 of another of the plurality of photovoltaic modules 302.

In some embodiments, each of the first layer 303 and the second layer 305 includes a polymer. In some embodiments, each of the first layer 303 and the second layer 305 includes thermoplastic polyolefin (TPO). In some embodiments, each of the first layer 303 and the second layer 305 includes a material selected from the group consisting of polyethylene terephthalate (PET), polyethylene naphthalate (PEN), polyetheretherketone (PEEK), polyaryletherketone (PAEK), polyarylate (PAR), polyetherimide (PEI), polyarylsulfone (PAS), polyethersulfone (PES), polyamideimide (PAI), or polyimide; polyvinyl chloride (PVC); ethylene propylene diene monomer (EPDM) rubber; silicone rubber; fluoropolymers-ethylene tetrafluoroethylene (ETFE), polyvinylidene fluoride (PVDF), tetrafluoroethylene-hexafluoropropylene copolymers (FEP), and tetrafluoroethylene-hexafluoropropylene-vinylidene fluoride copolymers (THV), and blends thereof.

In some embodiments, the first layer 303 and the second layer 305 are laminated. In some embodiments, the second layer 305 is ultrasonically welded to the first layer 303. In some embodiments, the second layer 305 is heat welded to the first layer 303. In some embodiments, the second layer 305 is thermally bonded to the first layer 303.

In some embodiments, the first layer 303 has a thickness of 1 mm to 20 mm. In some embodiments, the first layer 303 has a thickness of 1 mm to 15 mm. In some embodiments, the first layer 303 has a thickness of 1 mm to 10 mm. In some embodiments, the first layer 303 has a thickness of 1 mm to 5 mm. In some embodiments, the first layer 303 has a thickness of 1 mm to 4 mm. In some embodiments, the first layer 303 has a thickness of 1 mm to 3 mm. In some embodiments, the first layer 303 has a thickness of 1 mm to 2 mm. In some embodiments, the first layer 303 has a thickness of 5 mm to 20 mm. In some embodiments, the first layer 303 has a thickness of 5 mm to 15 mm. In some embodiments, the first layer 303 has a thickness of 5 mm to 10 mm. In some embodiments, the first layer 303 has a thickness of 10 mm to 20 mm. In some embodiments, the first layer 303 has a thickness of 10 mm to 15 mm. In some embodiments, the first layer 303 has a thickness of 15 mm to 20 mm.

In some embodiments, the first layer 303 has a thickness of 1 mm. In some embodiments, the first layer 303 has a thickness of 1.5 mm. In some embodiments, the first layer 303 has a thickness of 2 mm. In some embodiments, the first layer 303 has a thickness of 2.5 mm. In some embodiments, the first layer 303 has a thickness of 3 mm. In some embodiments, the first layer 303 has a thickness of 3.5 mm. In some embodiments, the first layer 303 has a thickness of 4 mm.

In some embodiments, the first layer 303 has a thickness of 4.5 mm. In some embodiments, the first layer 303 has a thickness of 5 mm. In some embodiments, the first layer 303 has a thickness of 10 mm. In some embodiments, the first layer 303 has a thickness of 15 mm. In some embodiments, the first layer 303 has a thickness of 20 mm. In some embodiments, the first layer 303 has a thickness of 25 mm. In some embodiments, the first layer 303 has a thickness of 30 mm.

In some embodiments, the plurality of photovoltaic modules 302 is installed directly to the roof deck 304. In some embodiments, each of the plurality of photovoltaic modules 302 is installed on the roof deck 304 by a plurality of fasteners. In some embodiments, the plurality of fasteners are installed through the head lap 307. In some embodiments, the plurality of fasteners includes a plurality of nails. In some embodiments, each of the plurality of photovoltaic modules 302 is installed on the roof deck 304 by an adhesive. In some embodiments, the roofing system 300 includes an underlayment layer installed on the roof deck 304. In some embodiments, the plurality of photovoltaic modules 302 overlay the underlayment layer.

In some embodiments, at least one electrical component 310 is electrically connected to a corresponding one of the plurality of photovoltaic modules 302. In some embodiments, the at least one electrical component 310 includes a plurality of electrical components 310. In some embodiments, the at least one electrical component 310 has a structure and function similar to the electrical component 10.

In some embodiments, the at least one electrical component 310 is located proximate to the head lap 307 of the corresponding one of the plurality of photovoltaic modules 302. In some embodiments, the at least one electrical component 310 is located on a surface of the head lap 307. In some embodiments, the at least one electrical component 310 is located on a surface of the head lap 307 proximate to the second layer 305.

In other embodiments, the at least one electrical component 310 has a structure and function similar to the electrical component 110. In some embodiments, the base 113 of the housing 112 of the at least one electrical component 310 is embedded within the head lap 307. As used herein, the term “embedded” means partially or fully enveloped or enclosed, and with respect to certain embodiments of the electrical component 310, the base 113 of the housing 112 is partially enveloped by or enclosed within the head lap 307. In some embodiments, the base 113 of the housing 112 is laminated with the head lap 307. In some embodiments, the base 113 of the housing 112 is attached to the head lap 307 by an adhesive. In some embodiments, the base 113 is ultrasonically welded to the head lap 307. In some embodiments, the base 113 is heat welded to the head lap 307. In some embodiments, the base 113 is thermally bonded to the head lap 307. In some embodiments, the base 113 is not adhered or attached to the head lap 307.

In some embodiments, the at least one electrical component 310 is located proximate to the first step flap 311 of the corresponding one of the plurality of photovoltaic modules 302. In some embodiments, the at least one electrical component 310 is located on a surface of the first step flap 311. In some embodiments, the at least one electrical component 310 is located on a surface of the first step flap 311 proximate to the second layer 305.

In some embodiments, the at least one electrical component 310 is located proximate to the second step flap 313 of the corresponding one of the plurality of photovoltaic modules 302. In some embodiments, the at least one electrical component 310 is located on a surface of the second step flap 313. In some embodiments, the at least one electrical component 310 is located on a surface of the second step flap 313 proximate to the second layer 305.

In other embodiments, the at least one electrical component 310 has a structure and function similar to the electrical component 110. In some embodiments, the base 113 of the housing 112 of the at least one electrical component 310 is embedded within the first step flap 311. In some embodiments, the base 113 of the housing 112 of the at least one electrical component 310 is embedded within the second step flap 313. As used herein, the term “embedded” means partially or fully enveloped or enclosed, and with respect to certain embodiments of the electrical component 310, the base 113 of the housing 112 is partially enveloped by or enclosed within the first step flap 311 or the second step flap 313, as applicable. In some embodiments, the base 113 of the housing 112 is laminated with the first step flap 311. In some embodiments, the base 113 of the housing 112 of the electrical component 310 is attached to the first step flap 311 by an adhesive. In some embodiments, the base 113 is ultrasonically welded to the first step flap 311. In some embodiments, the base 113 is heat welded to the first step flap 311. In some embodiments, the base 113 is thermally bonded to the first step flap 311. In some embodiments, the base 113 of the housing 112 is laminated with the second step flap 313. In some embodiments, the base 113 of the housing 112 of the electrical component 310 is attached to the second step flap 313 by an adhesive. In some embodiments, the base 113 is ultrasonically welded to the second step flap 313. In some embodiments, the base 113 is heat welded to the second step flap 313. In some embodiments, the base 113 is thermally bonded to the second step flap 313.

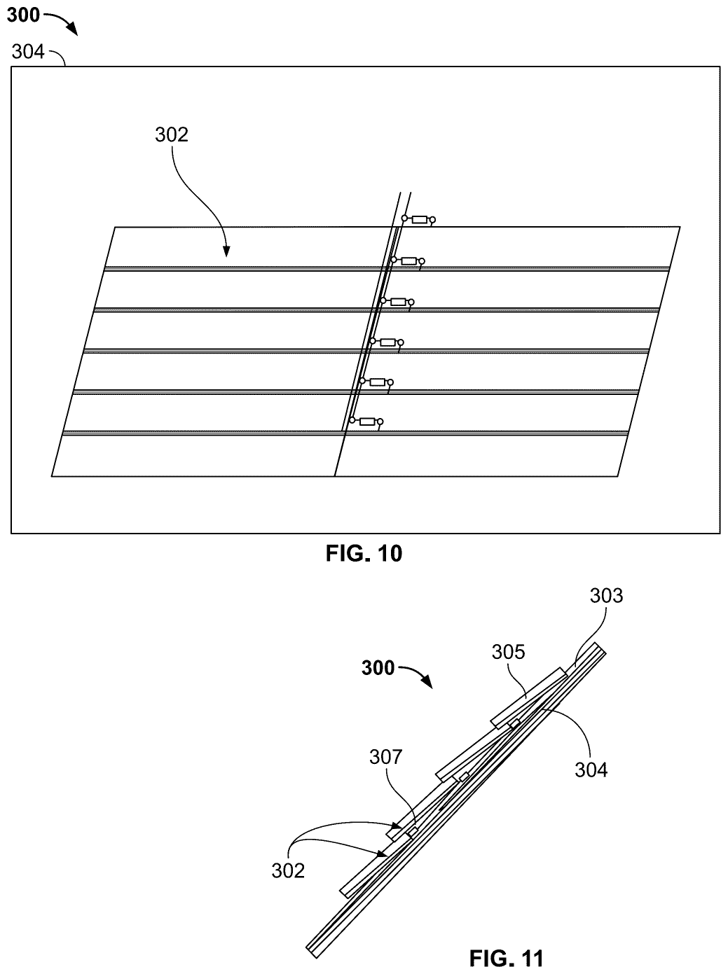

Referring to FIGS. 10 and 11, in an embodiment, the electrical component 310 of one of the plurality of photovoltaic modules 202 is located beneath the head lap 307 of the another overlaying one of the photovoltaic modules 202. In some embodiments, the electrical component 310 of one of the plurality of photovoltaic modules 202 located proximate to or on the first step flap 311 thereof is located beneath the second step flap 313 of the another overlaying one of the photovoltaic modules 202. In some embodiments, the electrical component 310 of one of the plurality of photovoltaic modules 202 located proximate to or on the second step flap 313 thereof is located beneath the first step flap 311 of the another overlaying one of the photovoltaic modules 202.

1-21. (canceled)

22. A system, comprising:
at least one photovoltaic module installed on a roof deck; and
at least one electrical component electrically connected to the at least one photovoltaic module,
wherein the at least one electrical component is proximate to the at least one photovoltaic module,
wherein the at least one electrical component includes
a base,
wherein the base is electrically connected to the at least one photovoltaic module, and
a cap,
wherein the cap includes an electronic component,
wherein the cap is moveable between an installed position, in which the cap is attached to the base and the electronic component is mechanically and electrically connected to the base, and a disconnected position, in which the cap is removed from the base and the electronic component is mechanically and electrically disconnected from the base.

23. The system of claim 22, wherein when the cap is in the disconnected position, the base remains electrically connected to the at least one photovoltaic module.

24. The system of claim 23, wherein when the cap is in the disconnected position, the at least one photovoltaic module remains installed on the roof deck.

25. The system of claim 22, wherein the electronic component includes at least one of an optimizer, a rapid shutdown device, an inverter, or a diode.

26. The system of claim 22, wherein the electronic component is a component of a junction box.

27. The system of claim 22, wherein the at least one electrical component is not mechanically mounted to the at least one photovoltaic module.

28. The system of claim 22, wherein the at least one photovoltaic module includes a plurality of photovoltaic modules, wherein the at least one electrical component includes a plurality of electrical components, wherein each of the plurality of electrical components is electrically connected to a corresponding one of the plurality of photovoltaic modules, and wherein each of the plurality of electrical components is proximate to a corresponding one of the plurality of photovoltaic modules.

29. The system of claim 28, wherein each of the plurality of photovoltaic modules includes a side lap, and wherein the corresponding one of the plurality of electrical components is located on the side lap.

30. The system of claim 29, wherein the plurality of photovoltaic modules is arranged in an array, wherein a first photovoltaic module of the plurality of photovoltaic modules is vertically adjacent to a second photovoltaic module of the plurality of photovoltaic modules, and wherein the side lap of the first photovoltaic module and the side lap of the second photovoltaic module form a wireway, and wherein the plurality of electrical components is located within the wireway.

31. The system of claim 30, further comprising at least one cover, wherein the at least one cover is removably attached to the wireway.

32. The system of claim 31, wherein the base of at least one of the plurality of electrical components is installed within the wireway, wherein the cap of the at least one of the plurality of electrical components is attached to one of the at least one cover, and wherein the electronic component of the at least one of the plurality of electrical components is mechanically and electrically connected to the base of the at least one of the plurality of electrical components when the at least one cover is attached to the wireway.

33. The system of claim 32, wherein the base of each of the plurality of electrical components is installed within the wireway, wherein the at least one cover includes a plurality of covers, wherein the cap of each of the plurality of electrical components is attached to a corresponding one of the plurality of covers, and wherein the electronic component of each of the plurality of electrical components is mechanically and electrically connected to the base of the corresponding one of the plurality of electrical components.

34. The system of claim 28, wherein each of the plurality of photovoltaic modules includes a head lap, and each of the plurality of electrical components is located on the head lap of the corresponding one of the plurality of photovoltaic modules.

35. The system of claim 22, wherein the base includes a plurality of slots, wherein the cap includes a plurality of tabs, and wherein each of the plurality of slots removably receives a corresponding one of the plurality of tabs.

36. The system of claim 35, wherein the base includes an upper surface, wherein the plurality of slots include a first slot in the upper surface and a second slot in the upper surface, wherein the cap includes an inner surface, wherein the plurality of tabs includes a first tab extending from the inner surface and a second tab extending from the inner surface.

37. The system of claim 36, wherein each of the first slot and the second slot includes a socket, and wherein each of the first tab and the second tab includes a pin.

38. The system of claim 37, wherein the base includes a first end and a second end opposite the first end, a first side extending from the first end to the second end, a second side opposite the first side and extending from the first end to the second end, wherein each of the first slot and the second slot extends longitudinally from the first end to the second end, wherein the cap includes a first end and a second end opposite the first end of the cap, a first side extending from the first end of the cap to the second end of the cap, a second side extending from the first end of the cap to the second end of the cap, wherein the first tab is proximate to the first side of the cap and the second tab is proximate to the second side of the cap.

39. The system of claim 38, wherein each of the first tab and the second tab extends longitudinally from the first end of the cap to the second end of the cap.

40. The system of claim 39, wherein the electronic component is attached to the inner surface of the cap between the first tab and the second tab

41. A system, comprising:
a plurality of photovoltaic modules installed on a roof deck;
a plurality of electrical components electrically connected to a corresponding one of the plurality of photovoltaic modules,
wherein each of the plurality of electrical components is proximate to the corresponding one of the plurality of photovoltaic modules,
wherein each of the plurality of electrical components includes
a base,
wherein the base is electrically connected to the corresponding one of the plurality of photovoltaic modules, and a cap,
wherein the cap includes an electronic component,
wherein the electronic component includes at least one of an optimizer, a rapid shutdown device, an inverter, or a diode,
wherein the cap is moveable between an installed position, in which the cap is attached to the base and the electronic component is mechanically and electrically connected to the base, and a disconnected position, in which the cap is removed from the base and the electronic component is mechanically and electrically disconnected from the base, and
wherein when the cap is in the disconnected position, the base remains electrically connected to the corresponding one of the plurality of photovoltaic modules.
